(19) United States
(12) Patent Application Publication
(10) Pub. No.: US 2021/0069944 A1
(43) Pub. Date: Mar. 11, 2021

(54) Method for sealing a seam, a composite part and use of same

(71) Applicants: KRAUSSMAFFEI TECHNOLOGIES GMBH, München (DE); COVESTRO DEUTSCHLAND AG, Leverkusen (DE)

(72) Inventors: Sebastian Eickens, Kevelaer (DE); Christian Kube, Siegburg (DE); Dieter Schendzielorz, Langenfeld (DE)

(21) Appl. No.: 16/958,863

(22) PCT Filed: Dec. 18, 2018
(86) PCT No.: PCT/EP2018/085451

§ 371 Date: Jun. 29, 2020

(30) Foreign Application Priority Data
Jan. 10, 2018 (EP) 18151020.7

(51) Int. Cl. B29C 44/12; B32B 5/20; B29C 44/14; B29C 44/50; B60R 13/02; B60N 2/75

(52) U.S. Cl. CPC B29C 44/1261; B32B 5/20; B29C 44/141; B29C 44/50; B29K 2075/00; B60N 2/793; B60R 13/0256; B32B 2266/0278; B32B 2605/003; B60R 13/0243

(57) ABSTRACT

A method for sealing seams of a surface layer containing the seams, the sealing being performed on the side of the surface layer to which a foam layer or adhesive layer is connected in a planar manner. The method further relates to a composite part and the use of same. The method preferably includes a non-contact, planar application of a sealing material onto the seam region along the course of the seam. With the help of the method it is possible to prevent the penetration of the foam or adhesive material in a subsequent processing step and at the same time to eliminate the disadvantages of the existing methods.

The invention relates to a method for sealing seams of a surface layer containing the seams, said sealing being performed on the side of the surface layer to which a foam layer is connected in a planar manner, composite parts of foam layer and surface layer with seams and the use of these composite parts.

Interior trim components for motor vehicles are generally made from plastics and frequently have a multi-layered structure of a carrier component and a surface layer. These are mostly injection moulded plastic components, in which decorative layers, decorative foils, moulded skins, fabrics, textile materials, leather or synthetic leather are used as the surface layer (subsequently designated as surface layer). Depending on the contour, structure and shape of the component, and in particular for visual reasons, frequently surface layers with functional seams or decorative seams are used here (subsequently designated as seams). As sewn surface layers, such as for example slush skins of PVC or of other thermoplastic polymers or else polyurethane foils are, however, pierced at the seam sites, in order to convey as realistic an impression as possible of a real sewn covering, they must generally be sealed before back-foaming along the seam, so that no foam material can penetrate through the seam sites onto the visible side of the surface layer. This can take place for example by the application of so-called sealing strips, wherein either cold adhesive strips of, for example, acrylate adhesive or fusing strips of, for example, heat-activatable copolyester adhesives or other adhesive strips can be used. Such sealing strips are described, for example, in DE 102010034598 A1. However, they have the disadvantage that they represent an increased risk of being apparent and are applied under pressure and heat. Furthermore, they have the disadvantage that contour jumps and radii can only be sealed to a limited extent by this method. The surface layer which can be present for example as a moulded skin, must be intensively processed under certain circumstances owing to the complexity of the geometry, so that the adhesive strip can be applied in a flat local execution. For this, the surface layer must be reached both from the decorative side (subsequently also designated as A side) and also from the inner side (subsequently also designated as B side) with a pusher roller or roll or respectively a support roller. The handling of the decorative surfaces, which are sensitive to damage, requires in addition a considerable effort with regard to care both in the manual and also automated use of the said adhesive strip seal.

In EP 3141369 A1 a method is described for sealing a seam of a moulded skin by means of plastisol, wherein the plastisol is applied onto the seam and is melted or respectively hardened at 160 to 180° C. A disadvantage in this method is that through the high temperature application both the thread of the seam and also, under certain circumstances, the base material of the surface layer can be affected, so that gloss or colour characteristics can be influenced in a disadvantageous manner or also ageing of the said materials can be disadvantageously accelerated. The described plastisol is, furthermore, not able to be used with all materials of the decorative foil materials which are used in automotive engineering because e.g. there is not sufficient adhesion on some materials. Furthermore, the application of the plastisol, generally in powder form, also in the application use for example in steep areas of contour course of a geometry is possible only with great effort or also with mechanical deformation of the decorative foil.

It is therefore an object of the present invention to prevent the disadvantages listed above in the sealing of seams, and to provide a method by which a reliable sealing of the seams of a surface layer is successful, so that with a process step, following the method of the invention, of the back foaming of the surface layer, the foam material, which is applied in fluid form, does not exit through the needle puncture holes of the seam and can not be absorbed by the sewing thread/decorative thread in such a way that the foam material can be transported in a wick effect onto the A side of the surface layer.

The same applies in the method when fluid adhesive is used for fixing the surface layer instead of foam material on a supporting workpiece. Here, likewise, the penetration of the adhesive through the needle puncture holes and the wick effect of the threads of the seam is to be prevented. Furthermore, the threads of the seam are not to be damaged or to be influenced in negative way in ageing or in colour characteristics.

This problem was able to be solved by the method according to the invention.

The subject of the invention is a method for sealing a seam (4) of a surface layer (2) containing this seam (4), with two sides (2a and 2b), which is part of a composite part (1), which has at least the surface layer (2) and a polyurethane foam layer or adhesive layer (3) applied in a planar manner on one of the sides (2a or 2b) of the surface layer (2), comprising the following method steps:
i) spraying or casting a sealing material (5) onto a planar application region on the side of the surface layer (2), to which the foam layer or adhesive layer (3) is connected, wherein the edge of the planar application region surrounds the seam (4),
ii) hardening of the sprayed-on or cast-on sealing material (5),
iii) applying of the polyurethane foam layer or adhesive layer (3) onto the side of the surface layer (3) on which the hardened sealing material (5) is situated,
   characterized in that the sealing material is a fluid reactive mixture based on polyurethane.

The reaction mixture does not contain any propellent, so that the sealing material is present as a compact material mass.

The method according to the invention preferably comprises the following method steps:
i) spraying or casting of the fluid reactive mixture based on polyurethane as sealing material (5), which has a temperature of 20° to 90° C., preferably 40° to 70° C., onto a planar application region on the side of the surface layer (3) to which the foam layer or adhesive layer (3) is connected, wherein the edge of the planar application region surrounds the seam (4),
ii) hardening of the sprayed-on or cast-on sealing material (5) at temperatures of 20° to 90° C., preferably 30° to 60° C., within 5 seconds to 5 minutes,
iii) applying the polyurethane foam layer (3) onto the side of the surface layer (2) on which the hardened sealing material (5) is situated.

The method according to the invention is preferably carried out in a contactless manner.

A further subject of the invention is a composite part (1) consisting of
a) a seam (4)
b) a surface layer (2) having this seam (4), with two sides (2a and 2b)
c) a polyurethane foam layer or adhesive layer (8) applied in a planar manner on one of the sides (2a or 2b) of the surface layer (2)
d) a planar application region of a sealing material (3) of a fluid reactive mixture based on polyurethane on the side of the surface layer (2) to which the polyurethane foam layer or adhesive layer (8) is connected, wherein the edge of the planar application region surrounds the seam (4).

The sealing material (3) is preferably a polyurethane reactive mixture of
a) at least one organic polyisocyanate selected from the group consisting of polyisocyanates based on diphenylmethane diisocyanate and/or polyphenyl-polymethylene polyisocyanate and modified organic polyisocyanates based on diphenylmethane diisocyanate,
b) at least one polyol with a number average molecular weight of 300 to 15000 g/mol, preferably of 320 to 13000 g/mol selected from the group consisting of polyether polyols, polyester polyols, polycarbonate diols and polyethercarbonate polyols,
c) if applicable chain extenders and/or crosslinking agents with number average molecular weights of 62 to <300 g/mol
d) catalysts
e) if applicable adjuvants and/or additives.

As polyisocyanate preferably organic and/or modified organic polyisocyanates based on diphenylmethane diisocyanate and/or polyphenyl-polymethylene polyisocyanate are used.

As polyols, preferably polyether polyols with a functionality of 2 to 6 are used.

As chain extenders and/or cross-linking agents, which can be used if applicable, the generally known chain extenders and/or cross-linking agents can be used. These are, for example, diethanolamine, triethanolamine, diethyltoluylene diamine, glycerin, 1,2-ethane diol, butane diol, diethylene glycol and isosorbide.

As catalysts, the catalysts known from polyurethane chemistry can be used. These are described for example in Adam, N., Avar, G., Blankenheim, H., Friederichs, W., Giersig, A L, Weigand, E., Halfmann, A L, Wittbecker, F.-W., Larimer, D.-R., Maier, U., Meyer-Ahrens, S., Noble, K.-L. and Wussow, H.-G. 2005. Polyurethanes. Ullmann's Encyclopedia of Industrial Chemistry, p. 555.

The adjuvants and additives which are present if applicable are described in Adam, N., Avar, G., Blankenheim, H., Friederichs, W., Giersig, M., Weigand, E., Halfmann, M., Wittbecker, F.-W., Larimer, D.-R., Maier, U., Meyer-Ahrens, S., Noble, K.-L. and Wussow, H.-G. 2005. Polyurethanes. Ullmann's Encyclopedia of Industrial Chemistry, p. 556.

For the polyurethane foam layer (8), polyurethane foams are used as are described for example in EP-A 2628756.

The surface layer (2) which is to be sealed preferably consists of a thermoplastic or thermosetting plastic. However, it can also consist of synthetic leather, treated or untreated leather or textile woven or non-woven materials. Preferably, polyvinylchloride (PVC), thermoplastic olefin (TPO) and polyurethane is used as plastic. These plastics can be produced for example by methods such as powder sintering (slush skin technology). The surface layer can preferably also consist of thermoplastic foil material, which is brought into the desired geometry by an upstream deep-drawing process, or else can consist of polyurethane foil materials. The surface layer (2) can be grained, structured or smooth on the side lying opposite the foam layer (8).

The thread of the seam can consist e.g. of natural materials such as wool, cotton or synthetic materials such as plastic.

In the method according to the invention for sealing a seam of a surface layer, the foil is firstly positioned in a contour-linked manner in a device, or in a planar manner on a supporting base, so that it can be provided in the desired position for the sealing method without any mechanical deformation. This device serves for the repeatable positioning of the surface layer and also for the contour supporting of the generally flexible foil material. The device can also be used for follow-up processes.

The seam which is introduced in the surface layer by a needle stitch sewing method has a product- and variant-specific course, which can be configured over contours and steep regions also in a segmented manner with interruptions.

In the method according to the invention, firstly the fluid polyurethane reactive mixture is sprayed on by means of an application nozzle or cast, and namely onto a planar application region, wherein the application region surrounds the seam according to the course. As a reactive mixture is involved, the material runs under applied conveying pressure through a mixing head which mixes the at least 2 components of the reactive mixture with one another as ideally as possible to a homogenous distribution of the components. The individual components of the reactive mixture are delivered here to the mixing head from a metering system in individual lines.

The reactive mixture fully reacts quickly and at low temperatures to the desired sealing material. This has the advantage that the thread of the seam and also the base material of the surface layer is not impaired at the low temperatures and that after only a short hardening time of the sealing material the foam for forming the foam layer, or the adhesive, can be subsequently applied.

The sealing effect is achieved by a good adhesion of the reactive mixture on the surface layer in the immediate vicinity of the course of the seam and also through the embedding of the sewing thread, projecting in a raised manner on the B-side on the surface layer, in the sealing material. The viscosity of the sealing material and also the short reaction time prevent the pressureless penetration of the needle stitch holes and the wick effect of the seam thread.

The viscosity and the adhesion characteristics of the reactive mixture are set here so that a contactless spraying- or casting effect can be used, in which also any steep regions of the contour which may exist can be wetted with the reactive mixture. Through the contactless application method, any mechanical stress of the surface layer by the sealing process is prevented. The actuation of the application nozzle also allows interruptions to be formed in the course of the seam in the application of material. Through a flexible track programming of a motion automaton, which directs the discharge nozzle along the course of the seam, complex movement sequences are able to be realized.

Various coordinations of the discharge nozzle permit the discharge cone or respectively the casting width to be limited. Thus, for example, additional air flows can be generated at the nozzle, which have a positive effect on the spraying- or casting behaviour. The stated discharge possibility of the casting makes possible the almost pressureless discharge, in which the sealing material is generally cast via a slot nozzle over the course of the seam.

In addition, variants of the sealing material can be modified with additives so that the sealing material is deposited in as contrasting a manner as possible to the colour of the material of the surface layer, in order to visually detect any misapplications with penetrations to the A side of the surface layer. This can be achieved by colourings of the material or e.g. fluorescent additives. A check can take place manually by visual inspection or automatically via image processing systems or other optical sensors. The same principles can be applied in order to check the B side application of the sealing material for quality and quantity.

The produced seal is also flexible in fully reacted state and in this respect is comparable in its characteristics to the flexible material of the surface layer.

The composite parts (1) can be used e.g. for the production of interior trim components for motor vehicles, such as for example instrument panels, armrests, door side trims, centre consoles and covers for glove compartments.

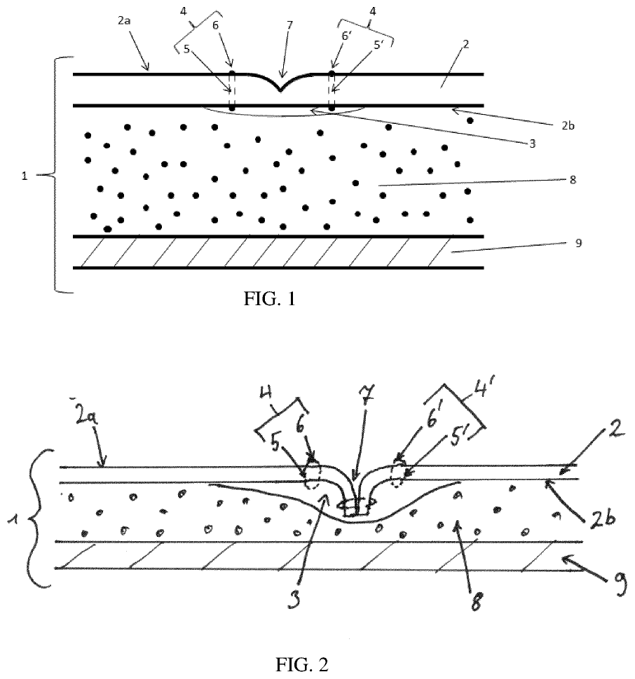

FIGS. 1, 2 and 3 show a composite part (1) of a surface layer (2) with two sides ((2a) and (2b)) with seams ((4) and (4′)) and with a foam layer (8) in cross-section:
1: composite part
2: surface layer with a visible side 2a (A side) and a side
2b (B side) facing the foam layer
3: sealing material of a polyurethane reactive mixture
4: seam
5: puncture of the thread
6: thread of the seam
7: indentation for the visual representation of a simulated joining location of two foil parts of the surface layer on the visible side 2a
7a: actual joining location of two surface layers
8: foam layer or adhesive layer
9: carrier layer

FIG. 1 shows a surface layer 2 in cross-section with a decorative seam. This decorative seam is a seam which is intended to convey the impression of two surface layers which are sewn to one another, but which does not physically contain any separation. The surface layer 2 has two decorative seams 4 with respectively a puncture 5. Between the two decorative seams 4, running substantially parallel to one another, an indentation 7 runs on a visible side 2a, which is intended to convey the impression that at this location two e.g. surface layers are sewn to one another (in the style of leatherworking). In order to provide a sealing of the decorative seams 4 for the back-foaming or planar bonding of the surface layer 2, the region between the two seam courses 4 and over the seam courses on the side 2b of the surface layer 2 which is to be foamed or is to be wetted with adhesive, is covered with sealing material 3. The punctures 5 of the two seams 4 are sufficiently covered by the sealing material 3 here so that it can be ruled out that the seam courses are reached by the back-foaming material or the adhesive material.

FIG. 2 shows a modification of FIG. 1. In this illustration, the use with an actual joining location 7a of the surface layer 2 is shown in cross-section.

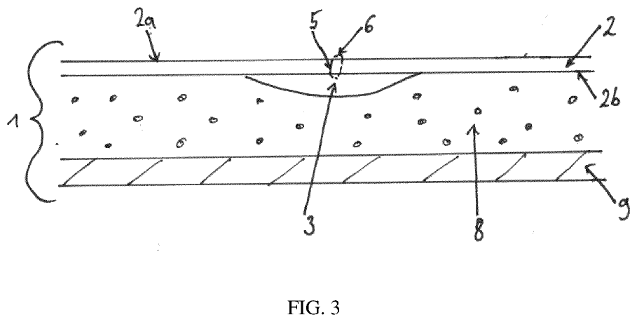

FIG. 3 shows a further modification of FIGS. 1 and 2. In this illustration, the use in a single seam course 4 is illustrated without a second seam 4′, running parallel, and without an indentation 7.

### EXAMPLE

Starting Compounds:
Polyol A: polyalkylene oxide based on glycerin as starter and propylene oxide with 18% terminal ethylene oxide block; OH-number 35 mg KOH/g polyol
Polyol B: polyalkylene oxide based on propylene glycol as starter and propylene oxide with 29% terminal ethylene oxide block; OH number 28 mg KOH/g polyol
Chain extender A: diethylene glycol
Chain extender B: 1,4 butanediol
Catalyst A: Dabco@NE1060 of the company Evonik, Essen
Catalyst B: FOMREZ® UL-28 of the company Momentive Performance Materials
Adjuvant A: Irganox® 1135 of the company BASF
Isocyanate: Desmodur® PC-N of Covestro Deutschland AG;
   diphenylmethane diisocyanate/polyphenylmethane polyisocyanate mixture of the company Covestro Deutschland AG with an NCO content of 26.0% by weight; viscosity at 25° C. of 120 mPa*s

Test Description:

The production took place in a heatable mould with a mould temperature of 25° C. The temperature of the polyol component (components b) to e)) was 70° C. and the temperature of the isocyanate component a) was 65° C. The components were mixed in the mixing head at a pressure of 130 bar (polyol component) or respectively 110 bar (isocyanate component) and sprayed on with decorative seam via an air-protected spray head onto an application region, surrounding the decorative seam, of the moulded skin present in the mould.

After a 2-minute hardening, in a further step a polyurethane foam layer was produced on the side of the moulded skin on which the hardened sealing material is situated. For this, a polyurethane reactive mixture consisting of the polyol component Bayfill® 531F40 of Covestro Deutschland AG and the isocyanate Desmodur®581F07 of Covestro Deutschland AG were applied onto the moulded skin with the sealed decorative seam via a high pressure mixing head in a heated mould at 42° C. and the mould was tightly closed. After 90 seconds at 42° C. the mould was opened and the composite element was removed. The tightness of the seal was checked visually.

Table: Composition of the polyurethane reactive mixture for the sealing of the seam

| Component | | |
|---|---|---|
| Polyol A | [Parts by weight] | 42.35 |
| Polyol B | [Parts by weight] | 44.05 |
| Chain extender A | [Parts by weight] | 2.00 |
| Chain extender B | [Parts by weight] | 11.00 |
| Catalyst A | [Parts by weight] | 0.08 |
| Catalyst B | [Parts by weight] | 0.02 |
| Adjuvant A | [Parts by weight] | 0.5 |
| Isocyanate | [Parts by weight] | 53 |
| Result: | | no passage of the |
| | | foam through the |
| | | holes of the seam |
| | | and no damage to the |
| | | seam or to the |
| | | thread |

What is claimed is:

1. A method for sealing a seam (4) of a surface layer (2) containing this seam (4), with two sides (2a and 2b), which is part of a composite part (1), which has at least the surface layer (2) and a polyurethane foam layer or adhesive layer (8) applied in a planar manner on one of the sides (2a or 2b) of the surface layer, comprising the following method steps:
i) spraying or casting of a sealing material (3) onto a planar application region on the side of the surface layer (2) to which the polyurethane foam layer or adhesive layer (8) is connected, wherein the edge of the planar application region surrounds the seam (4),
ii) hardening and adhering of the sprayed on or cast sealing material (3),
iii) applying the polyurethane foam layer (8) onto the side of the surface layer (2) on which the hardened sealing material (3) is situated,
wherein the sealing material (3) is a fluid reactive mixture based on polyurethane.

2. The method according to claim 1, wherein the method has the following method steps:
i) spraying or casting a sealing material (3), which has a temperature of 20° to 90° C., onto a planar application region on the side of the surface layer (2) to which the polyurethane foam layer or adhesive layer (8) is connected, wherein the edge of the planar application region surrounds the seam (4),
ii) hardening and adhering of the sprayed on or cast sealing material (3) at temperatures of 20° to 90° C., within 5 seconds to 5 minutes,
iii) applying the polyurethane foam layer (8) onto the side of the surface layer (2) on which the hardened sealing material (3) is situated.

3. The method according to claim 1, wherein the sealing material (3) is applied in a contactless manner via a spraying- or casting method onto the side of the surface layer (2) to which the polyurethane foam layer or adhesive layer (8) is connected.

4. The method according to claim 1, wherein the fluid polyurethane-based reactive mixture contains the following components:
a) at least one organic polyisocyanate selected from the group consisting of polyisocyanates based on diphenylmethane diisocyanate and/or polyphenylpolymethylene polyisocyanate and modified organic polyisocyanates based on diphenylmethane diisocyanate,
b) at least one polyol with a number average molecular weight of 300 to 15000 g/mol, selected from the group consisting of polyether polyols, polyester polyols, polycarbonate diols and polyethercarbonate polyols,
c) if applicable chain extenders and/or cross-linking agents with number average molecular weights of 62 to <300 g/mol,
d) catalysts
e) if applicable adjuvants and/or additives.

5. The method according to claim 1, wherein the surface layer (2) consists of a thermoplastic plastic.

6. The method according to claim 1, wherein the surface layer (2) consists of a thermosetting plastic.

7. The method according to claim 1, wherein the surface layer (2) consists of an elastomer plastic.

8. The method according to claim 1, wherein the surface layer (2) consists of a natural material.

9. The method according to claim 1, wherein the surface layer (2) consists of a synthetic textile, woven or non-woven material.

10. The method according to claim 1, wherein the surface layer (2) consists of a natural textile, woven or non-woven material.

11. The method according to claim 1, wherein the polyurethane foam (8) is formed by spraying-on a corresponding polyurethane reaction mixture onto the side of the surface layer (2) on which the sealing material (3) is situated.

12. The method according to claim 1, wherein the seam (4) is sewn with a thread which requires the piercing of the surface layer in a sewing method.

13. The method according to claim 1, wherein the thread of the seam (4) is embedded into the material of the surface layer in such a way that the thread has contact with the foam material or with the adhesive.

14. A composite part (1) consisting of
a) a seam (4)
b) a surface layer (2), containing this seam (4), with two sides (2a and 2b)
c) a polyurethane foam layer or adhesive layer (8) applied in a planar manner on one of the sides (2a or 2b) of the surface layer (2)
d) a planar application region of a sealing material (3) of a fluid reactive mixture based on polyurethane on the side of the surface layer (2) to which the polyurethane foam layer or adhesive layer (8) is connected, wherein the edge of the planar application region surrounds the decorative seam (4).

15. Use of the composite part (1) according to claim 14 for the production of instrument panels, armrests, door side trims, centre consoles and covers for glove compartments.
